(19) United States
(12) Patent Application Publication
(10) Pub. No.: US 2009/0255474 A1
(43) Pub. Date: Oct. 15, 2009

(54) Automatic aquarium feeder

(76) Inventor: Jerry Gleesing, Watertown, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/245,769

(22) Filed: Oct. 5, 2008

Related U.S. Application Data
(60) Provisional application No. 60/977,904, filed on Oct. 5, 2007.

(51) Int. Cl. A01K 61/02; G08B 21/00

(52) U.S. Cl. 119/51.04; 119/51.11; 340/540

(57) ABSTRACT

A digital, automatic feeder for aquarium and pond animals for positioning above an aquarium tank or pond for distributing a pre-measured amount of feed into the tank or pond on a pre-determined schedule. The feeder includes a digital system and display that allows users to input either a schedule of feed amounts and days/dates, or input a variety of tank conditions and allow the system to select an appropriate schedule and amounts of food.

### CLAIM OF PRIORITY

This invention claims priority to U.S. Provisional Application No. 60/977,904 filed on Oct. 5, 2007.

### FIELD OF INVENTION

This invention relates generally to the field of automatic aquarium feeders, and more specifically to aquarium feeders designed to sustain complex aquarium systems and feeding schedules.

### BRIEF DESCRIPTION OF THE DRAWINGS

FIG. 1 shows a front view of one embodiment of the automatic aquarium feeder.

FIG. 2 shows a side view of the embodiment of the automatic aquarium feeder in FIG. 1, with a device to attach the automatic aquarium feeder to a tank, pond, or stand.

FIG. 3 shows a bottom view of four alternate embodiments of the bottom grate of the automatic aquarium feeder's hopper.

FIG. 4 shows a side view of an embodiment of the digital automatic aquarium feeder hopper with attached mixing chamber and water source.

### BACKGROUND

Millions of aquariums are sold each year, as well as an increasing number of breeds of fish and other animals to stock them. It is desirable to have a device which minimizes the maintenance of aquariums and accommodates complex aquarium conditions and maintenance schedules. There are numerous automated aquarium feeding devices on the market that feed fish and other animals a designated amount of food at designated intervals. It is further desirable to have a device which accommodates various sizes of aquariums with varying amounts of food to accommodate the type and number of fish and other animals present in the aquarium and which allows the user to program the desired feeding intervals.

It is further desirable to have an automatic aquarium feeding device capable of functioning in larger industrial environments, such as fish farms, zoos, schools, factories and fish suppliers and vendors. It is desirable that an automatic aquarium feeder be easy to use, deliver precise amounts of food, and have the ability to dispense various types of food.

The present invention provides users the ability to feed aquarium animals on a varying or flexible feeding schedule, which may be more complex than the once-a-day schedules that are typical of timer-based aquarium feeders. The present invention further includes a digital display and system to aid the user in designating a feeding schedule based on factors including but not limited number of animals, types of animals, size of tank, water change schedule, temperature, chemical composition of the water, type of food used, humidity, and any other factor which may impact a feeding schedule.

As used herein, the term “aquarium” refers to a tank, pool, bowl, pond, lagoon, pool or aquatic eco-system, at least partially filled with water, for keeping live fish, aquatic animals, amphibians and reptiles.

As used herein, the term “feeding interval” refers to the length of time between feedings, and may be hours, days or weeks. As used herein, the term “auger” refers to a device for moving material or liquid by means of a rotar device which rotates inside a housing, moving the fish food through the hopper. The rotar device allows the hopper to open and cover the hopper aperture bottom aperture of the hopper, and control the length of time the hopper aperture is open. In various embodiments a hopper may be a roatational device, a lid with a hole, a spiral roating member and an internal cylindar.

As used herein, the term “hopper” refers to a temporary storage bin, normally filled from the top and emptied from the bottom.

As used herein, the term “digital” means any electronic or non-electronic device uses for tracking and/or displaying a quantity or numerica value. As used herein, digital means numeric.

As used herein, the term “navigation/input button” includes one or more buttons, touch pads, sensing devices or any digital or non-digital component which may on a user interfaces which may be accessed by a user to control the movement of an auger, any timing function of the appearance of an interface.

As used herein, the term “user interface display” means a display which responds to user input, which may be actuated by a navigation/input button or input button.

As used herein, the term “attachment member” means attachment member is selected from a group consisting of a bracket, a suction cup, a component which is integrally molded to an aquarium, a plate which includes a mounting track, a plate which includes mounting bolts, a plate which includes screws an adhesive.

### DETAILED DESCRIPTION OF EMBODIMENTS OF THE INVENTION

For the purpose of promoting an understanding of the present invention, references are made in the text hereof to embodiments of a digital automatic aquarium feeder, only some of which are depicted in the figures. It should nevertheless be understood that no limitations on the scope of the invention. are thereby intended. One of ordinary skill in the art will. readily appreciate that modifications such as the size and shape of the apparatus for automatically feeding aquarium and pond life, the inclusion of fewer and/or additional elements, ornamental features, and the inclusion of additional steps in the method of using the apparatus are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed system, structure, or manner.

It should be understood that the drawings are not necessarily to scale, emphasis instead being placed upon illustrating the principles of the invention. In addition, in the embodiments depicted herein, like reference numerals refer to identical or nearly identical structural elements in the various drawings.

Moreover, the term “substantially” or “approximately” as used herein may be applied to modify any quantitative representation that could permissibly vary without resulting in a change in the basic function to which it is related.

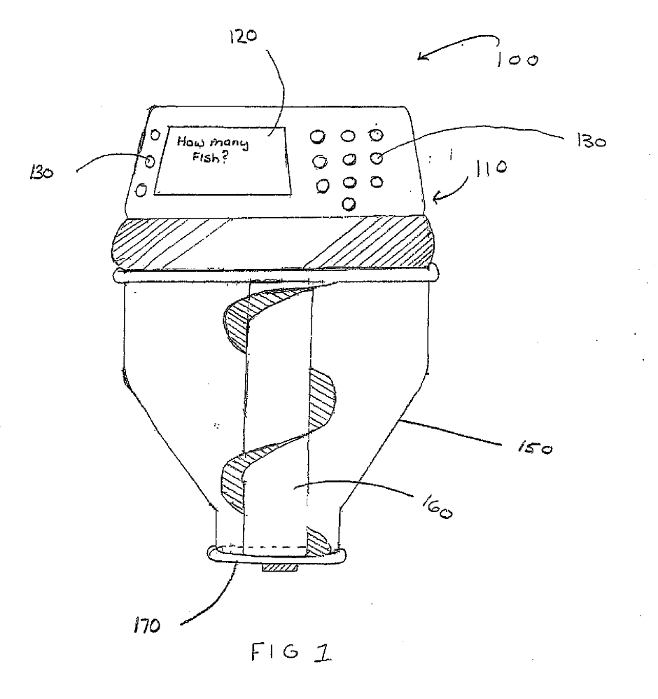

Referring now to the drawings, FIG. 1 shows a front view of an exemplary embodiment of automatic aquarium feeder 100. In the embodiment shown, automatic aquarium feeder 100 is comprised of digital top unit 110, located on the top of the automatic aquarium feeder 100, and containing digital display 120. The embodiment shown further includes navigation/input buttons 130, and an internal motorized device (not shown). Automatic aquarium feeder 100 also includes hopper 150, which is designed to contain animal feed and nutrients, vertically oriented auger device 160 located within hopper 150, and grate 170 at the bottom of hopper 150.

In the embodiment shown, digital display 120 displays a menu system allowing the user to input information into the automatic aquarium feeder 100 with navigation/input buttons 130. Navigation/input buttons 130 may be in various locations and configurations, and allow for a variety of user inputs. In the embodiment shown, input includes numbers, text, yes/no responses, enter, on/off, menu navigation such as up/down and left/right, and other input common to digital systems, but other embodiments may include additional buttons or allow for processing of additional input. Automatic acquarium feeder 100 and its compononents may be a color, a metallic finish, black whiter white, backlit and/or of a color and texture to conceal said of any size or shape, and may be constructed of any water resistant material. Digital display 120 may allow for the display of solely text or a combination of text and graphics.

In the embodiment shown, digital unit 110 allows the user to input a specific schedule of times, days/dates, and amounts of food to be released into the aquarium (not shown). Alternative embodiments may include additional functionality to allow the user to input aquarium conditions such as water capacity, number and types or sizes of animals, cleaning schedule, type of food contained in the hopper or other conditions that may affect feeding frequency, and allow digital automatic aquarium feeder 100 to select an appropriate feeding schedule. In other embodiments, automatic aquarium feeder 100 may be configured to track and store other important information, such as water changes, medicine dosing schedules, temperature, and the like and alert the caretaker to service that may be required on the aquarium. In addition, other embodiments of automatic aquarium feeder 100 may be configured to allow for a calibration routine to calibrate the delivered measurements of feed based on the type of feed in hopper 150, the style of bottom grate 170 on automatic aquarium feeder 100 in the event of interchangeable grates and other related factors.

Digital top unit 110 requires a power source. Such power source may include, but is not limited to, a power cord, a battery compartment for disposable batteries, an internal rechargeable battery, a solar power source, other power sources common to digital systems, or a combination of any of these.

In the embodiment shown, digital top 110 unit also contains a motorized mechanism (not shown) that causes vertically positioned auger 160 to rotate and deliver the feed.

In the embodiment shown, positioned below digital top unit 110, there is removably attached a hopper 150. As further shown in FIG. 1, hopper 150 is made of a rigid plastic material. However, in other embodiments, hopper 150 may be composed of any rigid, water resistant, aquarium-safe material such as glass, metal, fiberglass, or other natural or synthetic materials. In the embodiment shown, hopper 150 has is configured to hold various types of dry or semidry, free-flowing food or nutrition for aquarium life common to the art, such as pellets, flakes, wafers, powders, dried shrimp or insects, dried vegetable matter, dried algae, dried meat or fish, and other dried or semi-dried foodstuffs or a mixture of any of the above. Hopper 150 includes an aperture through which food is released by movement of an auger. In the embodiment shown, hopper 150 is filled by removing digital top unit 110, refilling with the desired food or food mixture, and replacing digital top unit 110. In other embodiments, digital top unit 110 may be permanently or removably attached to hopper 150 and there may be alternate means to fill hopper 150, such as a filling-hole or removable bottom grate 170.

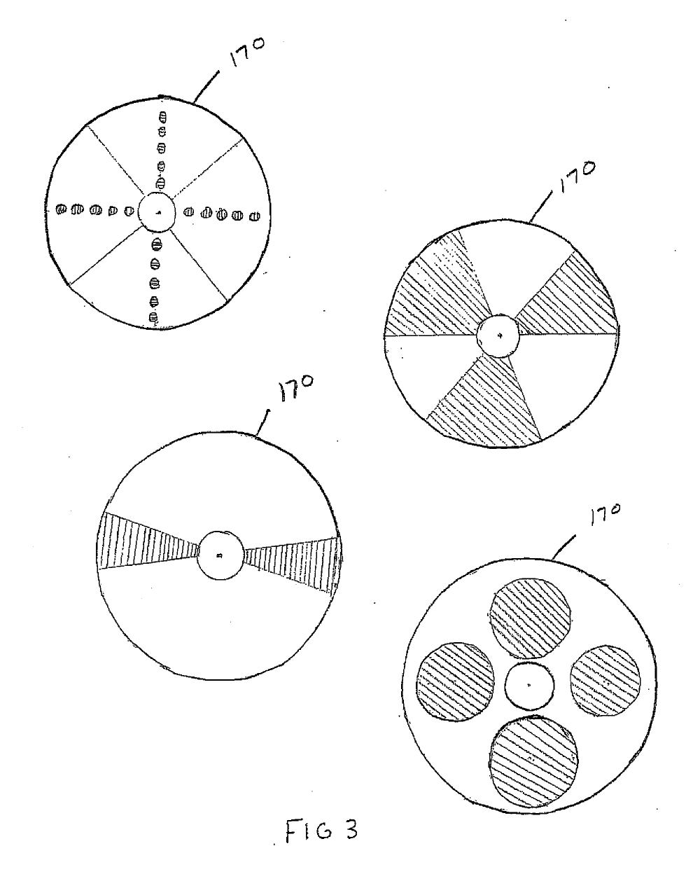

In the embodiment shown, contained within hopper 150, is vertically-oriented auger 160 that is used to move food over the openings in bottom grate 170, and into the aquarium. In the embodiment shown, a motorized component in digital top unit 110 causes vertically-oriented auger 160, to rotate, thus delivering food through the openings in bottom grate 170 as discussed in greater detail in FIG. 3. The vertically-oriented auger 160 may be of various sizes, shapes, or threading to accommodate the precision and movement necessary to deliver the food.

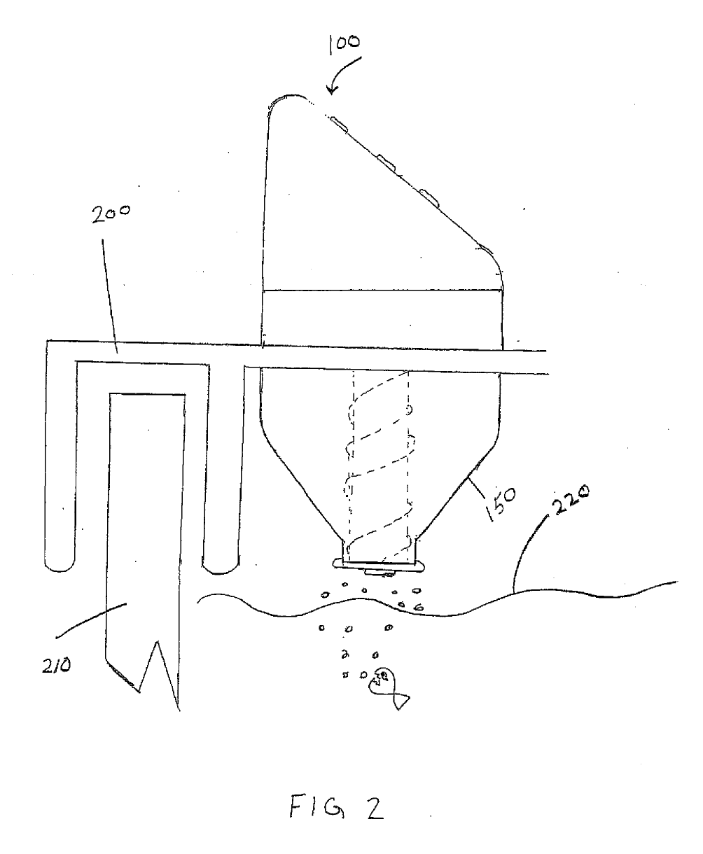

FIG. 2 shows a side view of the embodiment of digital automatic aquarium feeder 100, as in FIG. 1, along with one (1) embodiment of attachment and support member 200. In the embodiment shown, attachment member 200 which provides support and is mounted over aquarium edge 210 to position the feeder over aquarium water 220. In other embodiments, attachment and support member 200 may be of various sizes and shapes and may contain alternate methods of securing the device such as clips, a vice-like mechanism, spacers, or other means. In other embodiments, the attachment mechanism may be designed to be secured to the edges of a pond or a stand to allow flexibility of positioning. In the embodiment shown, the food is delivered from the bottom of hopper 150, directly to the surface of the water 220 in the tank.

FIG. 3 shows bottom views of four (4) embodiments of bottom grate 170. The embodiments shown in FIG. 3 of bottom grate 170 depict various configurations of the openings necessary to allow the food in the hopper (not shown) of the device to be delivered to the tank. The openings in bottom grate 170 may vary depending on the food being delivered and may be of any size or shape. In the embodiments shown, bottom grate 170 is composed of a rigid material such as plastic, but may be made from any water-resistant, aquarium-safe material. In other embodiments of digital automatic aquarium feeder 100, bottom grate 170 may be attached to the hopper unit, either permanently or removably, and may be user interchangeable or factory installed.

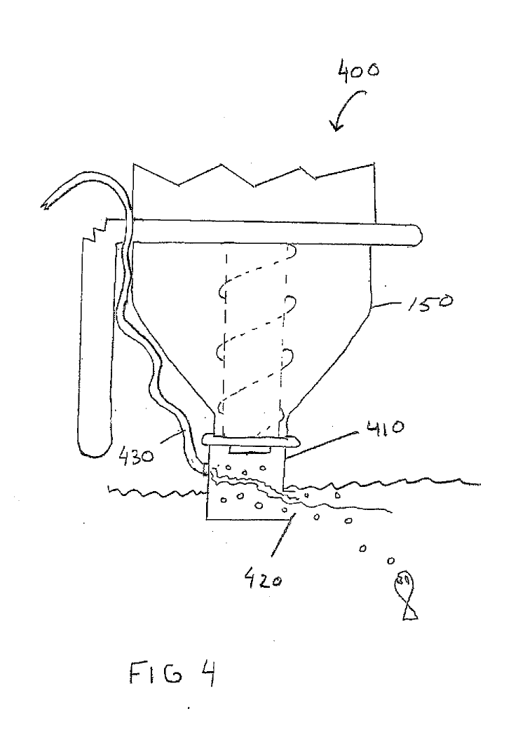

FIG. 4 shows a side view of another embodiment of the lower half of digital automatic aquarium feeder 100. In the embodiment shown, food is dropped from the bottom of hopper 150 and into mixing chamber 410, which allows the food to combine with water and be delivered to the aquarium under the water to be dispersed, instead of being delivered on the surface of the water. This is desirable in some applications as some aquarium life will not feed from the top. In the embodiment shown, there is an attached, partially submersed mixing chamber 410 which contains side opening 420 that allows food contents to move into the open water of the tank or pond. In other embodiments, this chamber may be of any shape or size, and may contain multiple openings in various positions. In the embodiment shown, attached permanently or removably to mixing chamber 410, is water source 430 that moves the contents of the mixing chamber into the open water of the aquarium. In other embodiments, the mixing chamber may not be attached to a water source, but rather, allow gravity or existing tank current to move the food mixture from the chamber.

While the digital automatic aquarium feeder has been shown and described with respect to several embodiments in accordance with the present invention, it is to be understood that the same is not limited thereto, but is susceptible to numerous changes and modifications as known to a person skilled in the art, and it is intended that the present invention not be limited to the details shown and described herein, but rather cover all such changes and modifications obvious to one of ordinary skill in the art.

1. An automatic aquarium feeder apparatus comprised of:
a digital top unit;
at least one navigation button;
a power source;
at least one time device which receives an input signal from said at least one navigation device; and
at least one housing containing an auger.

2. The automatic aquarium feeder apparatus of claim I which further includes a digital display.

3. The automatic aquarium feeder of claim 2 wherein said digital display is configured to display a value selected from a group consisting of number of fish, days fish are to be fed, fish type, number of gallons of tank, a food type and a chemical type.

4. The automatic aquarium feeder apparatus of claim 1 which further includes a user input device display.

5. The automatic aquarium feeder of claim 4 wherein said user input device display is configured to display a value selected from a group consisting of number of fish, days fish are to be fed, fish type, number of gallons of tank, a food type and a chemical type.

6. The automatic aquarium feeder of claim 1 which further includes a timing device which activates the movement of said auger.

7. The automatic aquarium feeder of claim 6 wherein said time device further activates an auger at timed intervals calculated using values selecting from a group consisting of display is configured to display a value selected from a group consisting of number of fish, days fish are to be fed, fish type, number of gallons of tank, a food type and a chemical type.

8. The automatic aquarium feeder of claim 1 which further includes an attachment member.

9. The automatic aquarium feeder of claim 8 wherein said attachment member is selected from a group consisting of a bracket, a suction cup, a component which is integrally molded to an aquarium, a plate which includes a mounting track, a plate which includes mounting bolts, a plate which includes screws an adhesive.

10. The automatic aquarium feeder of claim 1 which further includes an alarm to warn when food levels are low.

11. The automatic aquarium feeder of claim 10 wherein said alarm is selected from a group consisting of a beeper, an audible alarm, a warning light, a computer message, an electronic signal and a color indicator.

12. The automatic aquarium feeder of claim 1 wherein said housing contains a quantity of food ranging from one ounce to forty pounds of food.

13. The automatic aquarium feeder of claim 1 wherein said housing contains a quantity of food ranging from one ounce to forty pounds of food.

14. The automatic aquarium feeder of claim 1 which further includes multiple said at least one housing and augers, wherein said housing and augers are of varying sizes and shapes.

15. The automatic aquarium feeder of claim 1 wherein said automatic aquarium feeder further includes a housing of a shape selected from a group consisting of square, rectangular, cylindrical or irregularly shaped.

16. The automatic aquarium feeder of claim 1 wherein said automatic aquarium feeder further includes a housing of an ornamental design selected from a group consisting of a cylinder, a rectangle, fish replica, a plant replica, a rock replica, a coral replica, a human image replicas a shark, a boat and a diver.

17. An automatic aquarium feeder apparatus comprised of:
a digital top unit having a digital display which displays user input selected from a group consisting a value selected from a group consisting of number of fish, days fish are to be fed, fish type, number of gallons of tank, a food type and a chemical type,
at least one housing containing at least one auger;
at least one navigation button which receives user input which activates a digital display and a timing device which determines the timing interval by which said at least one auger is turned; and
at least one power source.

18. The automatic aquarium feeder of claim 1 wherein said digital display is configured to display a value selected from a group consisting of number of fish, days fish are to be fed, fish type, number of gallons of tank, a food type and a chemical type.

19. The automatic aquarium feeder of claim 1 which further includes an attachment member.

20. An automatic aquarium feeder apparatus comprised of:
a digital top unit having a digital display which displays user input selected from a group consisting a value selected from a group consisting of number of fish, days fish are to be fed, fish type, number of gallons of tank, a food type and a chemical type;
at least one housing containing at least one auger and wherein said automatic aquarium feeder further includes a housing of an ornamental design selected from a group consisting of a cylinder, a rectangle, fish replica, a plant replica, a rock replica, a coral replica, a human image replica, a shark, a boat and a diver;
at least one navigation button which receives user input which activates a digital display and a timing device which determines the timing interval by which said at least one auger is turned; and
at least one power source;
